(19) United States
(12) Patent Application Publication
(10) Pub. No.: US 2026/0061523 A1
(43) Pub. Date: Mar. 5, 2026

(54) WAFER PRODUCTION METHOD

(71) Applicant: DISCO CORPORATION, Tokyo (JP)

(72) Inventor: Yuya SETO, Tokyo (JP)

(21) Appl. No.: 19/316,504

(22) Filed: Sep. 2, 2025

(30) Foreign Application Priority Data
Sep. 4, 2024 (JP) 2024-152396

(51) Int. Cl. B23K 26/55; B23K 26/06; B23K 101/40

(52) U.S. Cl. CPC B23K 26/55; B23K 26/0665; B23K 2101/40

(57) ABSTRACT

A wafer production method for producing, from a workpiece being a nitride or oxide semiconductor, a wafer thinner than the workpiece, includes holding a back surface of the workpiece; forming a separation layer in an outer peripheral region of the held workpiece as defined herein; forming a separation layer in an inner region inside the outer peripheral region of the workpiece as defined herein, after the forming of the separation layer in the outer peripheral region; and separating a plate-shaped object from the workpiece as the wafer with the separation layers formed in the outer peripheral region and the inner region as a start point, and the forming of the separation layer in the outer peripheral region includes forming the separation layer at an inner position, and forming the separation layer at an outer position after the forming of the separation layer at the inner position.

### CROSS-REFERENCE TO RELATED APPLICATIONS

This application is based on and claims priority under 35 USC 119 from Japanese Patent Application No. 2024-152396 filed on Sep. 4, 2024, the contents of which are incorporated herein by reference.

### TECHNICAL FIELD

The present disclosure relates to a wafer production method.

### BACKGROUND ART

As a method for producing a wafer such as a semiconductor, Patent Literature 1 describes a method in which a laser beam having a transmission wavelength is focused and applied to a hexagonal single crystal ingot from a front surface side thereof to form a separation start point including a modified layer and a crack extending from the modified layer inside the ingot, and then a plate-shaped object is separated from the ingot to produce a wafer.

Patent Literature 1: JP2016-111143A

### SUMMARY OF INVENTION

When laser processing as described in Patent Literature 1 is performed on an ingot of a nitride or oxide semiconductor, gas may be generated inside the ingot. If the gas expands, the wafer to be produced may be damaged during the laser processing.

Therefore, a method may be considered in which, during the laser processing, a laser beam is first applied to an outer peripheral region of the ingot to form a separation layer exposed at an outermost peripheral edge (outer peripheral surface) of the ingot, thereby forming a gas discharge port. However, in order to reliably form the separation layer exposed at the outermost peripheral edge, it is necessary to apply a high-power laser beam, and there is a problem that the load on the wafer to be produced is large.

The present disclosure provides a wafer production method that can reliably form, in an outer peripheral region of a workpiece, a separation layer capable of discharging gas generated inside the workpiece, and reduce the power of a laser beam to be applied when forming the separation layer.

According to the present disclosure, there is provided a wafer production method for producing a wafer thinner than a workpiece, which is a nitride or oxide semiconductor, from the workpiece, the wafer production method including:
a holding step of holding a back surface of the workpiece;
a first separation layer forming step of forming a separation layer in an outer peripheral region of the workpiece held in the holding step by setting a focal point of a pulsed laser beam having a wavelength that transmits through the workpiece at a predetermined depth from a front surface of the workpiece and applying the laser beam to the outer peripheral region of the workpiece;
a second separation layer forming step of forming a separation layer in an inner region inside the outer peripheral region of the workpiece by applying the laser beam to the inner region with the focal point of the laser beam at the predetermined depth from the front surface of the workpiece, after the first separation layer forming step; and
a separating step of separating a plate-shaped object from the workpiece as the wafer with the separation layers formed in the first separation layer forming step and the second separation layer forming step as a start point, in which
the first separation layer forming step includes
   an inner processing step of forming the separation layer at an inner position inside an outermost peripheral edge of the outer peripheral region, and
   an outer processing step of forming the separation layer at an outer position outside the inner position after the inner processing step.

### BRIEF DESCRIPTION OF DRAWINGS

FIG. 1 is a perspective view illustrating a laser processing apparatus 1.

FIG. 2 illustrates a laser beam applying mechanism 8 of the laser processing apparatus 1.

FIG. 3 is a diagram illustrating a laser beam applying mechanism 8 according to a modification.

FIG. 4 is a flowchart of an embodiment of a wafer production method.

FIG. 5 is a top view of an ingot 11 in which an inner processing line L1 and an outer processing line L2 along which a separation layer 15 is formed in a first separation layer forming step S2 are indicated by dashed lines.

FIG. 6 is a diagram illustrating an inner processing step S21 and an outer processing step S22 of the first separation layer forming step S2.

FIG. 7 is a diagram illustrating the separation layers 15 formed in an outer peripheral region of the ingot 11 by the inner processing step S21 and the outer processing step S22 of the first separation layer forming step S2.

FIG. 8 is a diagram illustrating a second separation layer forming step S3.

FIG. 9 is a schematic side view of a separating apparatus 9, illustrating a state in which ultrasonic waves are applied to the ingot 11 by an ultrasonic oscillation unit 91.

FIG. 10 is a schematic side view of the separating apparatus 9, illustrating a state in which a wafer W is separated from the ingot 11 by a separating unit 96.

FIG. 11 is a diagram illustrating a first modification of the first separation layer forming step S2.

FIG. 12 is a diagram illustrating a second modification of the first separation layer forming step S2.

### DESCRIPTION OF EMBODIMENTS

Hereinafter, an embodiment of a wafer production method of the present disclosure will be described with reference to the accompanying drawings.

First, a laser processing apparatus 1 used in the wafer production method will be described.

### Laser Processing Apparatus

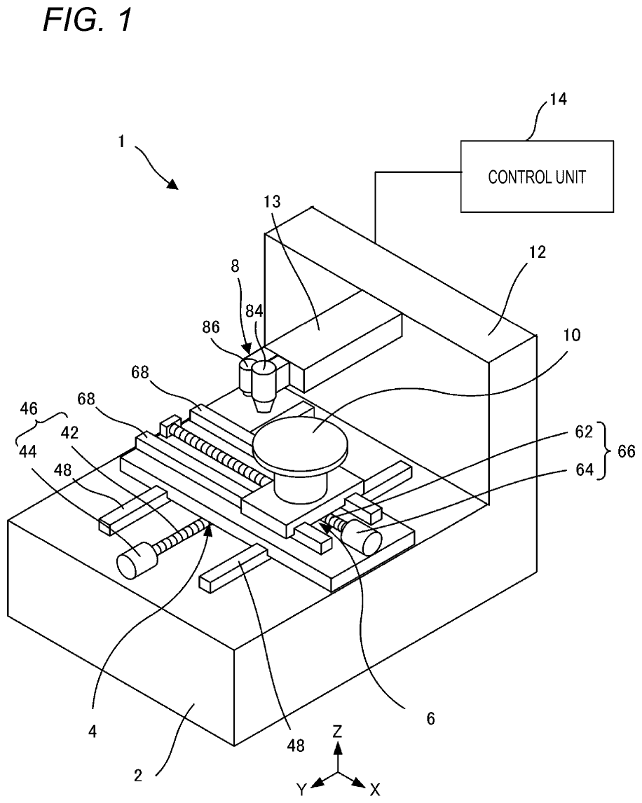

FIG. 1 is a perspective view illustrating the laser processing apparatus 1. In the following description, an X-axis direction is a direction on a horizontal plane. A Y-axis direction is a direction orthogonal to the X-axis direction on the horizontal plane. A Z-axis direction is a direction orthogonal to the X-axis direction and the Y-axis direction.

The laser processing apparatus 1 of the present embodiment includes a base 2, a first slide block 4 mounted on the base 2 so as to be movable in the Y-axis direction, a second slide block 6 mounted above the first slide block 4 and movable in the X-axis direction, a holding table 10 provided on the second slide block 6, a column 12 erected on the base 2, a laser beam applying mechanism 8 attached to the column 12, and a control unit 14 that controls the laser processing apparatus 1.

The first slide block 4 is movable in an indexing direction, that is, the Y-axis direction along a pair of guide rails 48 by an indexing mechanism 46 including a ball screw 42 and a pulse motor 44.

The second slide block 6 is mounted above the first slide block 4 so as to be movable in the X-axis direction. That is, the second slide block 6 is movable in a feeding direction, that is, the X-axis direction along a pair of guide rails 68 by a feeding mechanism 66 including a ball screw 62 and a pulse motor 64.

The holding table 10 is mounted on the second slide block 6. The holding table 10 is movable in the X-axis direction and the Y-axis direction by the feeding mechanism 66 and the indexing mechanism 46, and is rotatable by a motor accommodated in the second slide block 6.

The column 12 is erected on the base 2, and the laser beam applying mechanism 8 is attached to the column 12.

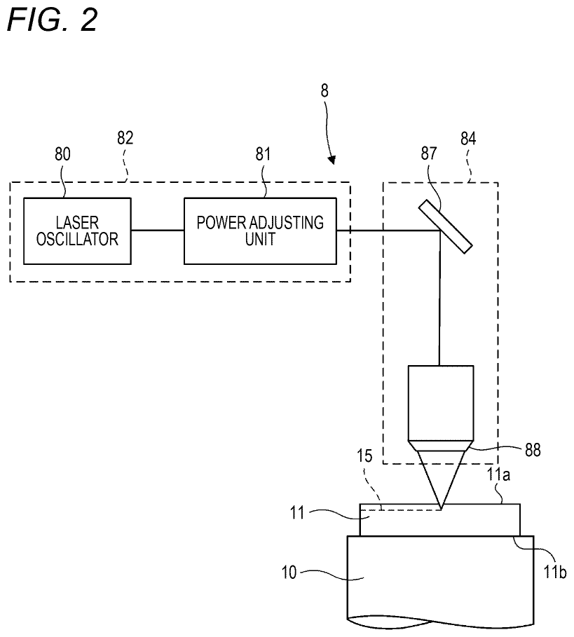

FIG. 2 is a diagram illustrating the laser beam applying mechanism 8 of the laser processing apparatus 1. As illustrated in FIGS. 1 and 2, the laser beam applying mechanism 8 includes a laser beam generating unit 82 accommodated in a casing 13 and a focusing means (laser head) 84 attached to a tip end of the casing 13. An imaging unit 86 having a microscope and a camera is attached to the tip end of the casing 13 adjacent to the focusing means 84.

The laser beam generating unit 82 includes a laser oscillator 80 that oscillates a YAG laser or a YVO4 laser, and a power adjusting unit 81. Although not particularly illustrated, the laser oscillator 80 has a Brewster window, and the laser beam emitted from the laser oscillator 80 is a linearly polarized laser beam.

The pulsed laser beam adjusted to a predetermined power by the power adjusting unit 81 of the laser beam generating unit 82 is reflected by a mirror 87 of the focusing means 84, and is applied by a focusing lens 88 at a focal point inside an ingot 11, which is an example of a workpiece fixed to the holding table 10.

The ingot 11 is a nitride or oxide semiconductor, and is, for example, an ingot of gallium nitride, gallium oxide, silicon nitride, or the like. The ingot 11 is not limited to a single crystal ingot and may be a polycrystalline ingot. The ingot 11 has a front surface 11a and a back surface 11b opposite to the front surface 11a. The front surface 11a of the ingot 11 is polished into a mirror finish as the front surface 11a is the surface to be applied with the laser beam. The ingot 11 has a thickness of, for example, 0.35 mm to 100 mm.

The control unit 14 controls each of the components of the laser processing apparatus 1 described above to cause the laser processing apparatus 1 to execute various processes on a workpiece. The control unit 14 is a computer including a controller that performs various calculations, a storage unit including a storage medium, and an input and output interface (not illustrated) that controls input and output of data between the inside and outside of the control unit 14. The controller includes, for example, a microprocessor such as a central processing unit (CPU). The storage unit includes a memory such as a hard disk drive (HDD), a read only memory (ROM), or a random access memory (RAM). The controller performs various calculations based on a predetermined program stored in the storage unit. The controller outputs, according to a calculation result, various control signals to the components described above via the input and output interface, and controls the laser processing apparatus 1.

As illustrated in FIG. 2, the laser processing apparatus 1 configured as described above forms a separation layer 15 including a plurality of modified regions and cracks extending from the modified regions inside the ingot 11. When forming the separation layer 15, the laser processing apparatus 1 sets a focal point of a laser beam having a wavelength (for example, a wavelength of 1064 nm) that transmits through the ingot 11 held by the holding table 10 at a position deeper than the front surface 11a of the ingot 11, and forms modified regions and cracks by focusing and applying the laser beam from the front surface 11a of the ingot 11.

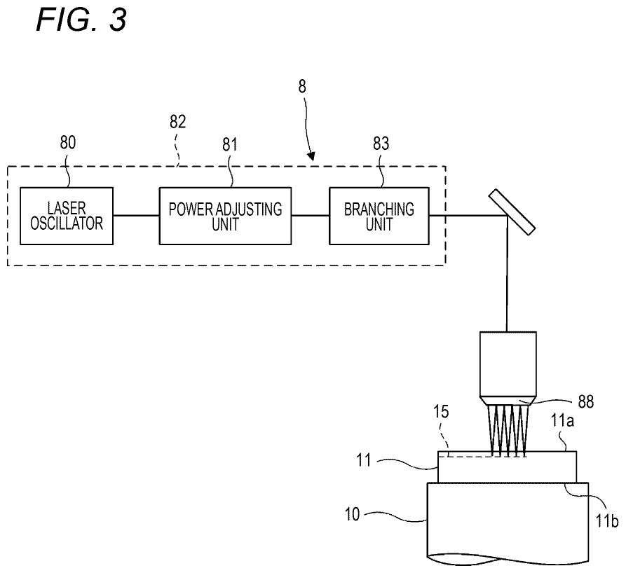

The laser beam applying mechanism 8 of the laser processing apparatus 1 is not limited to the configuration described above. FIG. 3 is a diagram illustrating a laser beam applying mechanism 8 according to a modification. In the laser beam applying mechanism 8 according to the modification, the laser beam generating unit 82 further includes a branching unit 83 in addition to the laser oscillator 80 and the power adjusting unit 81. The branching unit 83 branches a laser beam, the power of which is adjusted by the power adjusting unit 81, into a plurality of laser beams (for example, five laser beams) at predetermined intervals in a predetermined direction in an XY plane. For example, a plurality of modified regions and cracks can be formed at once by branching a laser beam into a plurality of laser beams.

### Wafer Production Method

Next, an embodiment of a wafer production method of the present disclosure will be described.

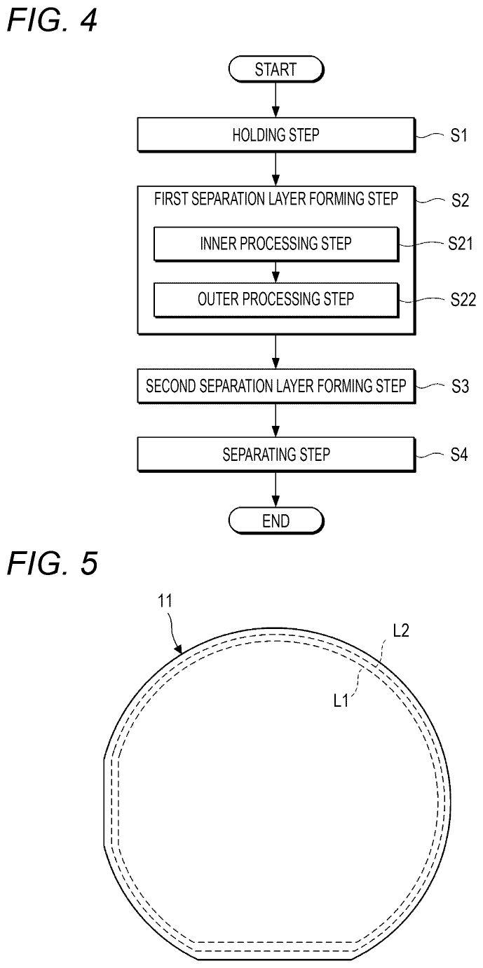

FIG. 4 is a flowchart of an embodiment of a method for producing a wafer W. The method for producing the wafer W includes: a holding step S1 of holding the back surface 11b of the ingot 11; a first separation layer forming step S2 of forming the separation layer 15 in an outer peripheral region of the ingot 11 held in the holding step S1 by setting a focal point of a pulsed laser beam having a wavelength that transmits through the ingot 11 at a predetermined depth from the front surface 11a of the ingot 11 and applying the laser beam to the outer peripheral region of the ingot 11; a second separation layer forming step S3 of forming the separation layer 15 in an inner region inside the outer peripheral region of the ingot 11 by applying the laser beam to the inner region with the focal point of the laser beam at the predetermined depth from the front surface 11a of the ingot 11, after the first separation layer forming step S2; and a separating step S4 of separating a plate-shaped object from the ingot 11 as the wafer W with the separation layers 15 formed in the first separation layer forming step S2 and the second separation layer forming step S3 as a start point. The process of each step is executed by the control unit 14.

### Holding Step

In the holding step S1, as illustrated in FIGS. 2 and 3, the back surface 11b of the ingot 11 is held by the holding table 10.

### First Separation Layer Forming Step

As described above, the ingot 11 is a nitride or oxide semiconductor. Therefore, when laser processing is performed by the laser processing apparatus 1, gas (for example, nitrogen gas or oxygen gas) is generated inside the ingot 11 (specifically, in modified regions and cracks). If the gas expands, the wafer W to be produced may be damaged during the laser processing.

Therefore, in the first separation layer forming step S2, the laser beam is first applied to the outer peripheral region of the ingot 11 to form a separation layer 15 exposed at an outermost peripheral edge of the ingot 11. Accordingly, a gas discharge port is formed at the outermost peripheral edge of the ingot 11. Here, the outer peripheral region of the ingot 11 is a region extending from the outermost peripheral edge of the ingot 11 to a position a predetermined distance (for example, about 200 μm) inward from the outermost peripheral edge. The outermost peripheral edge of the ingot 11 is a side surface 11c of the ingot 11.

In the present embodiment, the first separation layer forming step S2 includes an inner processing step S21 of forming the separation layer 15 at an inner position inside the outermost peripheral edge in the outer peripheral region, and an outer processing step S22 of forming the separation layer 15 at an outer position outside the inner position after the inner processing step S21.

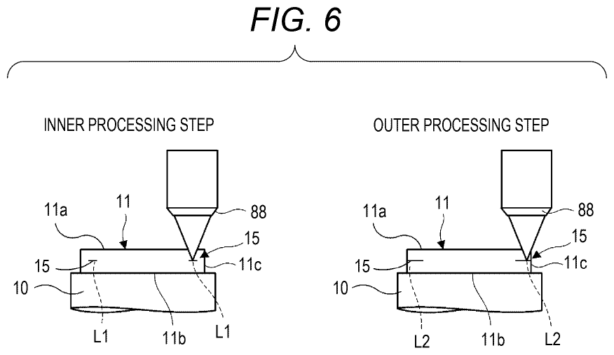

FIG. 5 is a top view of the ingot 11 in which an inner processing line L1 where the inner processing step S21 is performed and an outer processing line L2 where the outer processing step S22 is performed are indicated by dashed lines. FIG. 6 is a diagram illustrating the inner processing step S21 and the outer processing step S22.

In the inner processing step S21, a laser beam is applied to the position of the inner processing line L1 to form the separation layer 15 at the position of the inner processing line L1 along the entire circumference of the outermost peripheral edge of the ingot 11. In the outer processing step S22, after the inner processing step S21, a laser beam is applied to the position of the outer processing line L2 to form the separation layer 15 at the position of the outer processing line L2 along the entire circumference of the outermost peripheral edge of the ingot 11. The application position of the laser beam is adjusted under the control of the control unit 14.

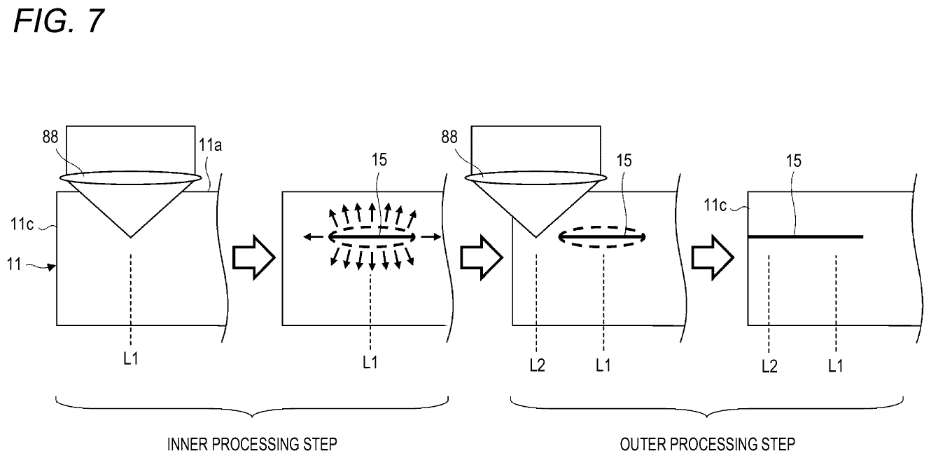

FIG. 7 is a diagram illustrating the separation layers 15 formed in the outer peripheral region of the ingot 11 in the inner processing step S21 and the outer processing step S22. When the laser beam is applied to the position of the inner processing line L1 and the separation layer 15 is formed in the inner processing step S21, the gas generated in the separation layer 15 expands. In the outer processing step S22, the separation layer 15 at the outer processing line L2 is exposed to the side surface 11c of the ingot 11 by utilizing a stress caused by the gas expanded inside the separation layer 15 at the inner processing line L1.

If the first separation layer forming step S2 includes only the outer processing step S22, the laser beam to be applied in the first separation layer forming step S2 needs to be set to a high power in order to reliably form the separation layer 15 exposed on the side surface 11c of the ingot 11, which increases the load on the wafer W to be produced.

On the other hand, the first separation layer forming step S2 of the present embodiment includes an inner processing step S21 and an outer processing step S22 performed after the inner processing step S21. When the separation layer 15 is formed at the position of the outer processing line L2 in the outer processing step S22, the separation layer 15 at the outer processing line L2 is exposed to the side surface 11c of the ingot 11 by utilizing the stress caused by the expansion of the gas generated in the separation layer 15 at the inner processing line L1. Therefore, even if a laser beam with a lower power is applied compared to the power of the laser beam in the case where the first separation layer forming step S2 includes only the outer processing step S22, the separation layer 15 exposed on the side surface 11c of the ingot 11 can be reliably formed, and the gas generated inside the ingot 11 during the formation of the separation layer 15 can be reliably discharged to the outside.

Incidentally, in the example illustrated in FIGS. 6 and 7, the laser beam applied from the laser processing apparatus 1 is not branched into a plurality of laser beams, but by using the laser processing apparatus 1 according to the modification illustrated in FIG. 3, the oscillated laser beam may be branched into a plurality of laser beams and then applied to the ingot 11 in the inner processing step S21 and the outer processing step S22. Accordingly, a processing speed of the inner processing step S21 and the outer processing step S22 can be increased.

### Second Separation Layer Forming Step

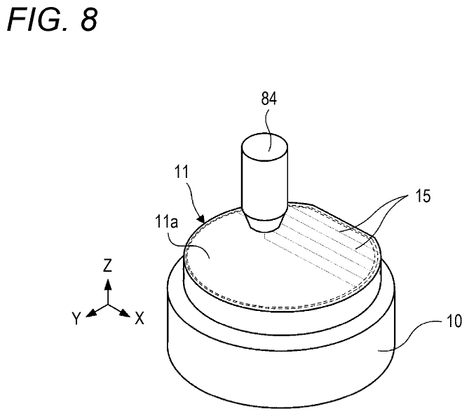

FIG. 8 is a diagram illustrating the second separation layer forming step S3. In the second separation layer forming step S3, after the first separation layer forming step S2, the separation layer 15 is formed in the inner region inside the outer peripheral region of the ingot 11. For example, in the second separation layer forming step S3, a process is repeated in which the ingot 11 is fed such that a focal point moves from one end to the other end of the ingot 11 along the X-axis direction to form modified regions and cracks along the X-axis direction, and after the ingot 11 is moved by a predetermined amount in the Y-axis direction, the ingot 11 is fed such that the focal point moves from the other end to the one end of the ingot 11 along the X-axis direction to form modified regions and cracks along the X-axis direction. Accordingly, the separation layer 15 is formed inside the ingot 11.

The gas generated during the second separation layer forming step S3 is discharged to the outside of the ingot 11 from the separation layer 15 exposed on the side surface 11c of the ingot 11 in an outer region.

### Separating Apparatus and Separating Step

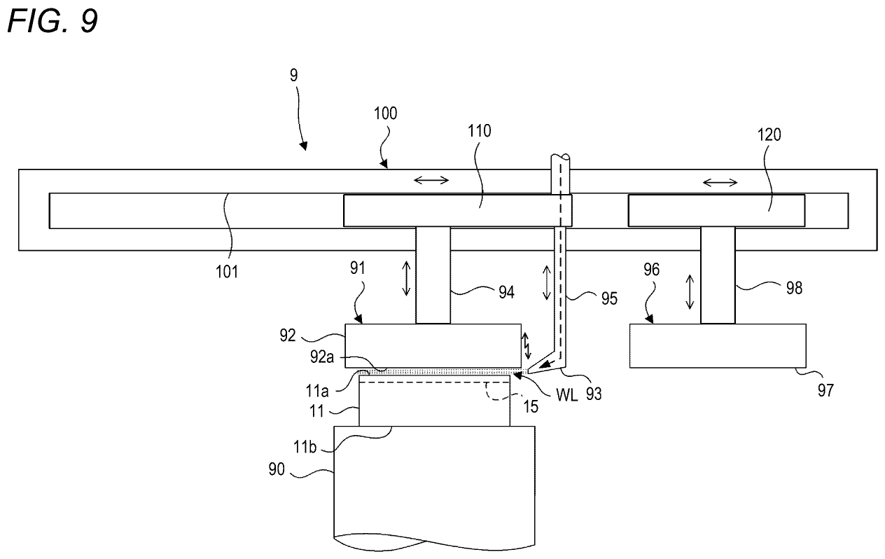

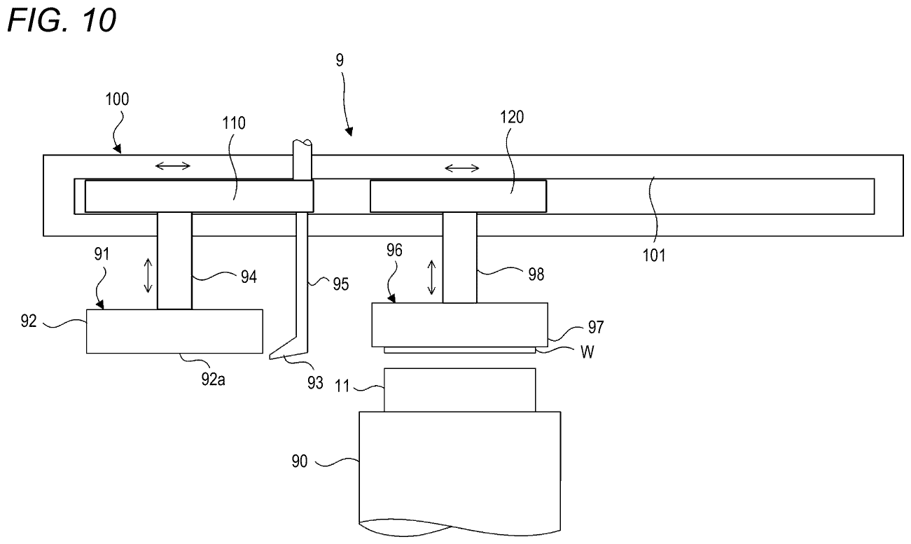

FIGS. 9 and 10 are schematic side views of a separating apparatus 9. FIG. 9 is a diagram illustrating a state in which ultrasonic waves are applied to the ingot 11, and FIG. 10 is a diagram illustrating a state in which the wafer W is separated from the ingot 11.

The separating apparatus 9 includes a cylindrical holding table 90 that holds the ingot 11 with the front surface 11a of the ingot 11 facing upward, an ultrasonic oscillation unit 91 that applies ultrasonic waves to the ingot 11, a separating unit 96 that separates the wafer W (see FIG. 10) from the ingot 11, and a moving mechanism 100 that moves the ultrasonic oscillation unit 91 and the separating unit 96 in a horizontal direction.

For example, the holding table 90 holds the ingot 11 via an epoxy resin-based adhesive, or holds the ingot 11 under suction by a suction force generated by a suction source (not illustrated). The holding table 90 is rotatable about an axis that passes through a radial center and extends in a vertical direction.

A rectangular opening 101 extending in the horizontal direction is formed in the moving mechanism 100, and a moving piece 110 supporting the ultrasonic oscillation unit 91 and a moving piece 120 supporting the separating unit 96 are movable along the opening 101. Although not illustrated, the moving mechanism 100 includes a ball screw coupled to the moving pieces 110 and 120, a motor that rotates the ball screw, and the like.

As illustrated in FIG. 9, the ultrasonic oscillation unit 91 includes an ultrasonic transducer 92 that has an end surface 92a facing the front surface 11a of the ingot 11 held by the holding table 90 and applies ultrasonic waves to the ingot 11, a liquid supply nozzle 93 that supplies a liquid (for example, pure water) between the front surface 11a of the ingot 11 and the end surface 92a of the ultrasonic transducer 92, a transducer lifting mechanism 94 that extends downward from a lower surface of the moving piece 110 and adjusts a vertical position of the ultrasonic transducer 92, and a nozzle lifting mechanism 95 that extends downward from the lower surface of the moving piece 110 and adjusts a vertical position of the liquid supply nozzle 93. The transducer lifting mechanism 94 and the nozzle lifting mechanism 95 are implemented by air cylinders, ball screws, motors, and the like. The dashed arrows in FIG. 9 indicate the flow of the liquid ejected from the liquid supply nozzle 93.

The ultrasonic transducer 92 is positioned at a position where a slight gap (for example, 0.6 mm) is provided between the end surface 92a and the front surface 11a of the ingot 11 by the transducer lifting mechanism 94. The ultrasonic waves applied to the ingot 11 have, for example, a frequency of 20 kHz to 50 kHz.

While the ultrasonic waves are being applied to the ingot 11, the liquid supply nozzle 93 continuously supplies the liquid to the gap between the end surface 92a of the ultrasonic transducer 92 and the front surface 11a of the ingot 11 to form a liquid layer WL. The ultrasonic waves emitted from the ultrasonic transducer 92 are transmitted to the ingot 11 via the liquid layer WL to extend the cracks of the separation layer 15 formed in the ingot 11. Accordingly, the strength of the separation layer 15 is reduced.

The separating unit 96 includes a suction pad 97 that holds under suction the wafer W to be separated from the ingot 11, and a pad lifting mechanism 98 that extends downward from a lower surface of the moving piece 120 and adjusts a vertical position of the suction pad 97. The pad lifting mechanism 98 is implemented by an air cylinder, a ball screw, a motor, and the like.

As illustrated in FIG. 10, after the ultrasonic waves are applied to the entire front surface 11a of the ingot 11, the moving pieces 110 and 120 move, and the suction pad 97 moves to a position facing the ingot 11 held on the holding table 90. Then, the separating unit 96 causes the suction pad 97 to suction the front surface 11a of the ingot 11 and moves the suction pad 97 upward, thereby separating, as the wafer W, a plate-shaped object including the front surface 11a of the ingot 11 from the separation layer 15 of the ingot 11.

The first separation layer forming step S2, the second separation layer forming step S3, and the separating step S4 as described above are repeatedly performed to produce a plurality of wafers W from the ingot 11.

### First Modification

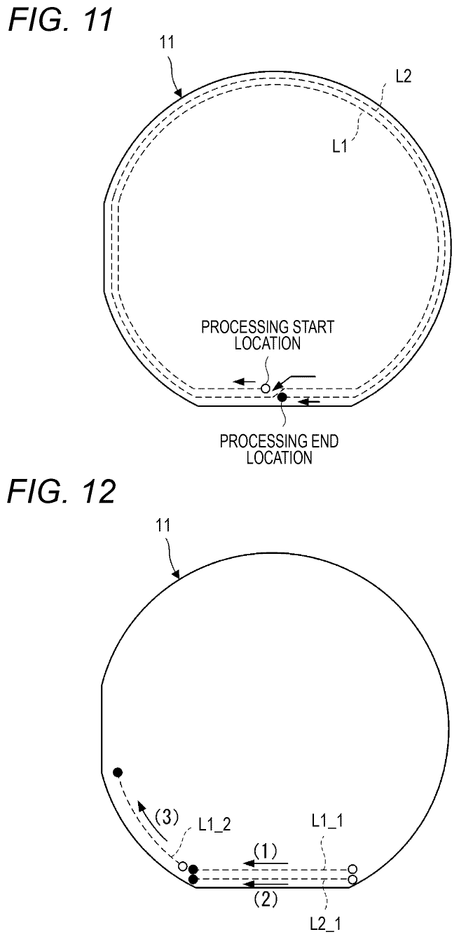

FIG. 11 is a diagram illustrating a first modification of the first separation layer forming step S2. As illustrated in FIG. 11, in the first modification of the first separation layer forming step S2, the inner processing step S21 and the outer processing step S22 are continuously performed. Specifically, after the inner processing step S21 is executed, the laser beam is continuously applied while moving from the end of the inner processing line L1 to the start of the outer processing line L2, and then the outer processing step S22 is executed. According to the first modification, the processing time of the first separation layer forming step S2 can be shortened.

### Second Modification

FIG. 12 is a diagram illustrating a second modification of the first separation layer forming step S2. As illustrated in FIG. 12, in the second modification of the first separation layer forming step S2, in both the inner processing step S21 and the outer processing step S22, the entire circumference is not processed at once, but the inner processing step S21 and the outer processing step S22 are repeated a plurality of times.

Specifically, the inner processing line L1 and the outer processing line L2 are divided into a plurality of lines in a circumferential direction. The laser processing apparatus 1 applies a laser beam to the position of a first inner division processing line L1_1 to form a separation layer 15 along the inner division processing line L1_1 ((1) inner processing step S21). Thereafter, the laser processing apparatus 1 applies a laser beam to the position of an outer division processing line L2_1 parallel to an outer peripheral side of the inner division processing line L1_1 to form a separation layer 15 along the outer division processing line L2_1 ((2) outer processing step S22). Thereafter, the laser processing apparatus 1 applies a laser beam to the position of an inner division processing line L1_2 adjacent to the first inner division processing line L1_1 to form a separation layer 15 along the inner division processing line L1_2 ((3) inner processing step S21). Thereafter, the outer processing step S22 and the inner processing step S21 are repeated for circumferentially adjacent processing lines. In the second modification, the same effects as those of the embodiment and the first modification described above can also be obtained.

Although an embodiment and modifications of the present disclosure have been described above with reference to the accompanying drawings, it is needless to say that the present disclosure is not limited to that embodiment. It is obvious that those skilled in the art may come up with various changes or modifications within the scope of the claims, and it is understood that these naturally fall within the technical scope of the present disclosure. In addition, components in the embodiment described above may be freely combined without departing from the gist of the disclosure.

For example, the wafer production method of the embodiment described above has been described by taking the case where the workpiece is the ingot 11 as an example, but the present disclosure is not limited thereto, and the workpiece may be the wafer W, for example. That is, one wafer W may be further divided into a plurality of wafers by performing the wafer production method of the embodiment described above on one wafer W.

The present specification describes at least the following matters. Corresponding components and the like in the embodiment described above are shown in parentheses as an example, but the present disclosure is not limited thereto.

(1) A wafer production method for producing a wafer (wafer W) thinner than a workpiece (ingot 11), which is a nitride or oxide semiconductor, from the workpiece, the wafer production method including:
a holding step (holding step S1) of holding a back surface (back surface 11b) of the workpiece;
a first separation layer forming step (first separation layer forming step S2) of forming a separation layer (separation layer 15) in an outer peripheral region of the workpiece held in the holding step by setting a focal point of a pulsed laser beam having a wavelength that transmits through the workpiece at a predetermined depth from a front surface (front surface 11a) of the workpiece and applying the laser beam to the outer peripheral region of the workpiece;
a second separation layer forming step (second separation layer forming step S3) of forming a separation layer in an inner region inside the outer peripheral region of the workpiece by applying the laser beam to the inner region with the focal point of the laser beam at the predetermined depth from the front surface of the workpiece, after the first separation layer forming step; and
a separating step (separating step S4) of separating a plate-shaped object from the workpiece as the wafer with the separation layers formed in the first separation layer forming step and the second separation layer forming step as a start point, in which
the first separation layer forming step includes an inner processing step (inner processing step S21) of forming the separation layer at an inner position (inner processing line L1, inner division processing line) inside an outermost peripheral edge of the outer peripheral region, and an outer processing step (outer processing step S22) of forming the separation layer at an outer position (outer processing line L2, outer division processing line) outside the inner position after the inner processing step.

According to (1), since the first separation layer forming step includes an inner processing step and an outer processing step performed after the inner processing step, when a separation layer is formed in the outer processing step, a stress caused by expansion of gas generated in the separation layer at the inner position can be utilized. Therefore, even if a low-power laser beam is applied, a separation layer exposed at the outermost peripheral edge of the workpiece can be reliably formed, and the gas generated inside the workpiece can be reliably discharged to the outside.

(2) The wafer production method according to (1), in which
in the outer processing step, the separation layer at the outer position is exposed on a side surface (side surface 11c) of the workpiece by utilizing a stress caused by a gas generated when the laser beam is applied in the inner processing step and expanded inside the separation layer at the inner position.

According to (2), even if a low-power laser beam is applied, a separation layer exposed at the outermost peripheral edge of the workpiece can be reliably formed, and the gas generated inside the workpiece can be discharged to the outside.

(3) The wafer production method according to (1) or (2), in which
in the inner processing step, the laser beam is applied to the inner position (inner processing line L1) to form the separation layer at the inner position along the entire circumference of the outermost peripheral edge, and
in the outer processing step, after the inner processing step, the laser beam is applied to the outer position (outer processing line L2) to form the separation layer at the outer position along the entire circumference of the outermost peripheral edge.

According to (3), since the outer processing step is performed after the separation layer is formed along the entire circumference of the outermost peripheral edge in the inner processing step, a processing speed of the first separation layer forming step can be increased.

(4) The wafer production method according to (3), in which
the inner processing step and the outer processing step are continuously executed.

According to (4), the processing time of the first separation layer forming step can be shortened.

### REFERENCE SIGNS LIST

11 ingot (workpiece)
11a front surface
11b back surface
11c side surface
15 separation layer
W wafer
L1 inner processing line (inner position of outer peripheral region)
L2 outer processing line (outer position of outer peripheral region)
S1 holding step
S2 first separation layer forming step
S21 inner processing step
S22 outer processing step
S3 second separation layer forming step
S4 separating step

What is claimed is:

1. A wafer production method for producing a wafer thinner than a workpiece, which is a nitride or oxide semiconductor, from the workpiece, the wafer production method comprising:
holding a back surface of the workpiece;
forming a separation layer in an outer peripheral region of the held workpiece by setting a focal point of a pulsed laser beam having a wavelength that transmits through the workpiece at a predetermined depth from a front surface of the workpiece and applying the laser beam to the outer peripheral region of the workpiece;
forming a separation layer in an inner region inside the outer peripheral region of the workpiece by applying the laser beam to the inner region with the focal point of the laser beam at the predetermined depth from the front surface of the workpiece, after the forming of the separation layer in the outer peripheral region; and
separating a plate-shaped object from the workpiece as the wafer with the separation layers formed in the outer peripheral region and the inner region as a start point, wherein
the forming of the separation layer in the outer peripheral region includes
forming the separation layer at an inner position inside an outermost peripheral edge of the outer peripheral region, and
forming the separation layer at an outer position outside the inner position after the forming of the separation layer at the inner position.

2. The wafer production method according to claim 1, wherein
in the forming of the separation layer at the outer position, the separation layer at the outer position is exposed on a side surface of the workpiece by utilizing a stress caused by a gas generated when the laser beam is applied in the forming of the separation layer at the inner position and expanded inside the separation layer at the inner position.

3. The wafer production method according to claim 1, wherein
in the forming of the separation layer at the inner position, the laser beam is applied to the inner position to form the separation layer at the inner position along an entire circumference of the outermost peripheral edge, and
in the forming of the separation layer at the outer position, after the forming of the separation layer at the inner position, the laser beam is applied to the outer position to form the separation layer at the outer position along the entire circumference of the outermost peripheral edge.

4. The wafer production method according to claim 2, wherein
in the forming of the separation layer at the inner position, the laser beam is applied to the inner position to form the separation layer at the inner position along an entire circumference of the outermost peripheral edge, and
in the forming of the separation layer at the outer position, after the forming of the separation layer at the inner position, the laser beam is applied to the outer position to form the separation layer at the outer position along the entire circumference of the outermost peripheral edge.

5. The wafer production method according to claim 3, wherein
the forming of the separation layer at the inner position and the forming of the separation layer at the outer position are continuously executed.

6. The wafer production method according to claim 4, wherein
the forming of the separation layer at the inner position and the forming of the separation layer at the outer position are continuously executed.
